(19) United States
(12) Patent Application Publication
(10) Pub. No.: US 2024/0344175 A1
(43) Pub. Date: Oct. 17, 2024

(54) PROCESSES FOR RECOVERING METALS FROM BLACK MASS

(71) Applicant: CVMR Corporation, Toronto (CA)

(72) Inventors: Nanthakumar Victor Emmanuel, Toronto (CA); Kamran M. Khozan, Toronto (CA); Mohammad Al Quayyum, Toronto (CA)

(21) Appl. No.: 18/638,295

(22) Filed: Apr. 17, 2024

Related U.S. Application Data
(60) Provisional application No. 63/496,610, filed on Apr. 17, 2023.

(51) Int. Cl. C22B 26/12; C22B 3/04; H01M 10/54

(52) U.S. Cl. CPC C22B 26/12; C22B 3/04; H01M 10/54

(57) ABSTRACT

There is provided a process for a process for recovering one or more metals from black mass. The process includes separating lithium from the black mass such that a lithium-depleted black mass is obtained, and converting at least a portion of the lithium-depleted black mass, via a reactive process, to at least a non-lithium elemental metal.

The present disclosure relates to recovering metals from black mass.

### BACKGROUND

Battery production could be limited by global supply shortages of key metals employed in such production. Recycling of spent batteries, for purposes of recovering these key metals, could help preserve a reliable supply chain for battery production.

### SUMMARY

In one aspect, there is provided a process for recovering one or more metals from black mass, comprising:
contacting the black mass with a soluble lithium material formation reagent with effect that a conditioned black mass material is produced, wherein the conditioned black mass material includes a lithium-comprising ionic compound material that is defined by at least one lithium-comprising ionic compound;
contacting a lixiviant-ready black mass material, deriving from the conditioned black mass material, with a lixiviant with effect that a lixiviant-conditioned mixture is produced; and
separating a separation-ready mixture, deriving from the lixiviant-conditioned mixture, into at least a lithium-rich liquid material and a lithium-depleted residual solid material.

In another aspect, there is provided a process for recovering one or more metals from black mass, comprising:
separating lithium from the black mass such that a lithium-depleted black mass is obtained; and
converting at least a portion of the lithium-depleted black mass, via a reactive process, to at least a non-lithium elemental metal.

### BRIEF DESCRIPTION OF DRAWINGS

The preferred embodiments of the process will now be described with reference to the following accompanying drawings, in which:

FIG. 1 is a flowsheet illustrating an embodiment of the process.

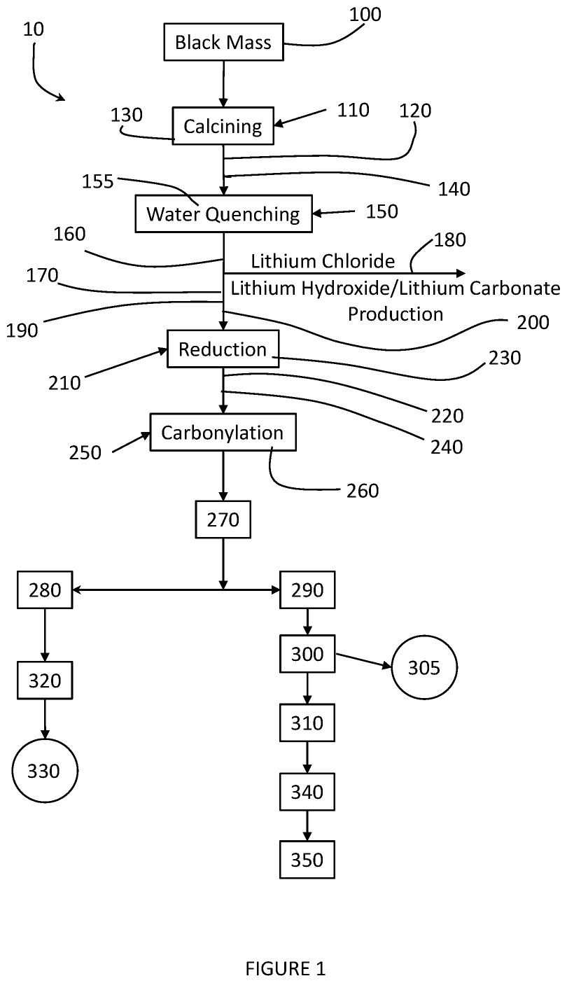

### DETAILED DESCRIPTION

There is provided a process 10 for recovering metallic material from a spent energy storage device, such as, for example, a spent battery.

In some embodiments, for example, the process 10 includes discharging the spent energy storage device, dismantling the discharged spent energy storage device with effect that energy storage device components are obtained, separating the energy storage device components with effect that an electrode is obtained, effecting size reduction (such as, for example, by grinding, crushing, and/or shredding) of the electrode with effect that size-reduced material is obtained. In some embodiments, for example, the size-reduced material is particulate material. In some embodiments, for example, at least 90 weight % of the size-reduced material has a particle size of less than three (3) millimetres. In some embodiments, for example, at least 90 weight % of the size-reduced material has a particle size of less than two (2) millimetres. In some embodiments, for example, at least 90 weight % of the size-reduced material has a particle size of less than one (1) millimetre. In some embodiments, for example, the size-reduced material is particulate material, and at least 90 weight % of the size-reduced material has a particle size, and the particle size is from 500 micrometres to one (1) millimetre.

In some embodiments, for example, black mass 100 is obtained. In some embodiments, for example, the black mass 100 is derived from the size-reduced material. In some embodiments, for example, the black mass 100 is the size-reduced material.

In some embodiments, for example, the black mass 100 includes a plurality of black mass-based metals. In some embodiments, for example, the plurality of black mass-based metals includes lithium and at least one non-lithium metal. In some embodiments, for example, the at least one non-lithium metal is nickel, cobalt, manganese, or any combination thereof. In some embodiments, for example, for each one of the at least one non-lithium metal, independently, the non-lithium metal is present in the form of an oxide of the non-lithium metal. In some embodiments, for example, the black mass metal material includes at least five weight % of lithium, based on the total weight of the black mass material, such as, for example, at least 7.5 weight % of lithium, based on the total weight of the black mass material, such as, for example, at least ten (10) weight % of lithium, based on the total weight of the black mass material. In some embodiments, for example, the ratio, of: (i) the total weight of lithium, of the black mass metal material to (ii) the total weight of the non-lithium metal material, of the black mass metal material, is at least 0.059. In some embodiments, for example, the ratio, of: (i) the total weight of lithium, of the black mass metal material, to (ii) the total weight of the non-lithium metal material, of the black mass metal material, is from 0.059 to 0.23.

In some embodiments, for example, the at least one non-lithium metal includes lithium, nickel, cobalt, and manganese. In some of these embodiments, for example, the at least one non-lithium metal is a mixture of lithium, nickel, cobalt, and manganese. In some embodiments, for example, the nickel, of the black mass 100, is in the form of an oxide of nickel, the cobalt, of the black mass 100, is in the form of an oxide of cobalt, the manganese, of the black mass 100, is in the form of an oxide of manganese, and the lithium, of the black mass 100, is in the form of an oxide of lithium. In some embodiments, for example, the black mass 100 includes about 25 weight % to 35 weight % nickel, based on the total weight of the black mass, from 20 weight % to 30 weight % cobalt, based on the total weight of the black mass, from 15 weight % to 25 weight % manganese, based on the total weight of the black mass, and from five (5) weight % to 15 weight % lithium, based on the total weight of the black mass.

In some embodiments, for example, the black mass 100 is contacted with a soluble lithium material formation reagent 110 with effect that a conditioned black mass material 120 is produced. The conditioned black mass material 120 includes a lithium-comprising ionic compound material. The at least one lithium-comprising ionic compound material is defined by at least one lithium-comprising ionic compound. The conditioned black mass material 120 further includes a non-lithium metal-comprising post-conditioning material. In some embodiments, for example, the conditioned black mass material 120 is in molten form.

In some embodiments, for example, the contacting of the black mass 100 and the soluble lithium material formation reagent 110 is with effect that a reactive process is effected. In some embodiments, for example, the reactive process, that is effected in response to the contacting of the black mass 100 and the soluble lithium material formation reagent 110, effects the production of the conditioned black mass material 120. In some embodiments, for example, the reactive process, that is effected in response to the contacting of the black mass 100 and the soluble lithium material formation reagent 110, includes calcining of the black mass 100. In some embodiments, for example, the calcining is with effect that porosity of the conditioned black mass material is greater than the porosity of the black mass material. In some embodiments, for example, the calcining is effected at a temperature that is greater than 1000 degrees Celsius (such as, for example, 1050 degrees Celsius) and at atmospheric pressure. This, in some embodiments, provides increased opportunity for disposition of a reagent in proximity, with the conditioned black mass material, that is effective for stimulating a reactive process, relative to that with the original black mass. In some embodiments, for example, the contacting of the black mass 100 and the soluble lithium material formation reagent 110 is effected within a first material transformation zone 130.

In some embodiments, for example, for each one of the at least one lithium-comprising ionic compound, independently, the lithium-comprising ionic compound has a structure represented by the following general formula (I):

AB
wherein:
   A is a lithium ion; and
   B is an anion.

In some embodiments, for example, the soluble lithium material formation reagent 110 is a solid material.

In some embodiments, for example, the soluble lithium material formation reagent 110 includes a halide ion-donating material, such that B, of formula (I), is a halide ion.

In some embodiments, for example, the halide-ion donating material includes at least one halogen atom, and, in this respect, the at least one halogen atom is defined by a fluorine atom, a chlorine atom, a bromine atom, an iodine atom, an astatine atom, a tennessine atom, or any combination thereof.

In some embodiments, for example, the halide-ion donating material is a metal-based halide ion donating material, and the metal-based halide ion donating material is an alkali metal halide material (defined by at least one alkali metal halide), an alkaline earth metal halide material (defined by at least one alkaline earth metal halide), or a combination of an alkali metal halide material and an alkaline earth metal halide material.

Suitable halide-ion donating materials include calcium chloride and sodium chloride.

In those embodiments where the halide-ion donating materials include calcium chloride, in some of these embodiments, for example, the produced lithium-comprising ionic compound includes lithium chloride.

In some embodiments, for example, within the first material transformation zone 130, the ratio, of: (i) the total number of moles of halogen atoms to (ii) the total number of moles of lithium atoms is at least 1:1, such as, for example at least 2:1.

In some embodiments, for example, within the first material transformation zone 130, the ratio, of: (i) the total weight of the metal-based halide ion donating material to (ii) the total weight of black mass, is from 1:99 to 1:4.

In some embodiments, for example, the first material transformation zone 130 is disposed at a first material transformation zone temperature, and the first material transformation zone temperature is from 900 degrees Celsius to 1300 degrees Celsius, such as, for example, from 1000 degrees Celsius to 1200 degrees Celsius. In some embodiments, for example, the first material transformation zone temperature is 1100 degrees Celsius. In some embodiments, for example, the first material transformation zone is disposed at atmospheric pressure. In some embodiments, for example, the first material transformation zone is disposed under atmospheric air.

In some embodiments, for example, a lixiviant-ready black mass material 140, deriving from the conditioned black mass material 120, is contacted with a lixiviant 150 with effect that a lixiviant-conditioned mixture 160 is produced. In some embodiments, for example, the lixiviant-ready black mass material 140 is the conditioned black mass material 120. In some embodiments, for example, the contacting with the lixiviant 150 is with effect that leaching of the lixiviant-ready black mass material 140 is effected. The leaching is with effect that a leachate is produced, and the leachate includes the lithium-comprising ionic compound material. In some embodiments, for example, the lixiviant 150 is an aqueous lixiviant, such that the lithium-rich liquid material is an aqueous material. In some embodiments, for example, the lixiviant 150 is water. In some embodiments, for example, the contacting with the lixiviant 150 is effected within a second material transformation zone 155.

In some embodiments, for example, a separation-ready mixture 170, deriving from the lixiviant-conditioned mixture 160, is separated into at least a lithium-rich liquid material 180 and a lithium-depleted residual solid material 190. In some embodiments, for example, the lithium-rich liquid material is derived from the leachate, and, in some of these embodiments, is the leachate. In some embodiments, for example, the separation-ready mixture is the lixiviant-conditioned mixture. In some embodiments, for example, the separation is effected via mechanical filtration, gravity separation, or a combination thereof.

The concentration of lithium within the lithium-rich liquid material 180 is greater than the concentration of lithium within the lithium-depleted residual solid material. In some embodiments, for example, the ratio of: (i) the concentration of lithium within the lithium-rich liquid material to (ii) the concentration of lithium within the lithium-depleted residual solid material is at least four (4), such as, for example, at least 5.7, such as, for example, at least nine (9).

In some embodiments, for example, the lithium-depleted residual solid material includes less than three (3) weight % lithium, based on the total weight of the lithium-depleted residual solid material.

The lithium-rich liquid material includes dissolved lithium and may also include, to a lesser extent (if any), at least one dissolved non-lithium metal. The dissolved lithium is derived from the lithium of the black mass 100. For each one of the at least one dissolved non-lithium metal, independently, the dissolved non-lithium metal is derived from a respective one of the at least one non-lithium metal of the black mass 100, such that the at least one dissolved non-lithium metal is derived from a respective at least one non-lithium metal of the black mass 100. In some embodiments, for example, the black mass 100 and the soluble lithium material formation reagent 110 are co-operatively configured such that the ratio of: (i) the fraction of the total weight of lithium, of the black mass 100, that is lithium from which the dissolved lithium is derived, to (ii) the fraction of the total weight of the at least one non-lithium metal, of the black mass 100, that is the respective at least one non-lithium metal from which the at least one dissolved non-lithium metal is derived, is at least 16, such as, for example, at least 40, such as, for example, at least 80.

In those embodiments where the produced lithium-comprising ionic compound includes lithium chloride, the lixiviant-ready black mass material 140 includes lithium chloride, and, in such embodiments, where the lixiviant 150 is an aqueous liquid, in some of these embodiments, for example, the lithium-rich liquid material 180 is aqueous and includes aqueous lithium chloride.

In some embodiments, for example, elemental lithium is recovered from the lithium-rich liquid material 180. In some embodiments, for example, the lithium chloride could be hydrolyzed to produce lithium hydroxide, which is a useable form for batter production.

In some embodiments, for example, the contacting with the lixiviant 150 effects a quenching of the calcining, and, in this respect, is with additional effect that a granulation is effected, and the granulation is with effect that at least 90 weight % of the lithium-depleted residual solid material has a particle size of less than three (3) millimetres, such as, for example. In some embodiments, for example, the granulation is with effect that at least 90 weight % of the lithium-depleted residual solid material has a particle size of less than two (2) millimetres. In some embodiments, for example, the granulation is with effect that at least 90 weight % of the lithium-depleted residual solid material has a particle size of less than one (1) millimetre. In some embodiments, for example, the granulation is with effect that at least 90 weight % of the lithium-depleted residual solid material has a particle size, and the particle size is from 500 micrometres to one (1) millimetre.

In some embodiments, for example, the temperature of the second material transformation zone 155, within which the contacting between the lixiviant-ready black mass 140 and the lixiviant 150 is effected, is from 800 degrees Celsius to 1000 degrees Celsius, and the pressure of the second material transformation zone 155 is atmospheric pressure (e.g. under atmospheric air). In this respect, in some embodiments, for example, the lixiviant is water, and the temperature of the lixiviant is from 800 degrees Celsius to 1000 degrees Celsius, and is disposed under atmospheric air, and the contacting is such that the lixiviant-ready black mass 140 is poured into the water.

In some embodiments, for example, a reduction-ready residual solid material 200, derived from the lithium-depleted residual solid material ′90, is contacted with a reducing agent 210, with effect that a reduced residual solid material 220 is obtained. In some embodiments, for example, the reduction-ready residual solid material 200 is the lithium-depleted residual solid material 190. In some embodiments, for example, the contacting is with effect that a reactive process is effected. In some embodiments, for example, the reactive process, that is effected in response to the contacting of the reduction-ready residual solid material 200 and the reducing agent 210, effects the production of the reduced residual solid material 220. In some embodiments, for example, the reducing agent 210 includes gaseous molecular hydrogen, gaseous carbon monoxide, carbon, or any combination thereof. In some embodiments, for example, the contacting with the reducing agent material is effected within a third material transformation zone 230. In some embodiments, for example, the temperature within the third material transformation zone 230 is from 400 degrees Celsius to 650 degrees Celsius. In some embodiments, for example, the pressure within the third material transformation zone 230 is atmospheric.

In some embodiments, for example, the reduced residual solid material 220 includes at least one non-lithium elemental metal, and each one of the at least one non-lithium elemental metal, independently, is derived from a respective one of the at least one non-lithium metal of the black mass-based metals. In this respect, in some embodiments, for example, the contacting of a reduction-ready residual solid material 200 and a reducing agent 210 is with effect that the at least one non-lithium elemental metal, of the reduced residual solid material 220, is produced.

In some embodiments, for example, the separation of a separation-ready mixture 170 into at least a lithium-rich liquid material 180 and a lithium-depleted residual solid material 190, such that the reduction-ready residual solid material 200, deriving from the lithium-depleted residual solid material 90, is depleted in lithium, mitigates agglomeration which would otherwise be effected during the reducing of the reduction-ready residual solid material 200, and which would otherwise interfere with recovery of metals.

In some embodiments, for example, a carbonylation-ready residual solid material 240, deriving from the reduced residual solid material 220, is contacted with a metal carbonyl formation reagent 250 with effect that a metal carbonyl material-comprising material is produced. In some embodiments, for example, the carbonylation-ready residual solid material is the reduced residual solid material. In some embodiments, for example, the metal carbonyl material-comprising material includes at least one metal carbonyl. Each one of the at least one metal carbonyl, independently, is a carbonyl of a respective one of the at least one non-lithium metal of the black mass-based metals of the black mass 100. In some embodiments, for example, the contacting with a metal carbonyl formation agent is with effect that a reactive process is effected. In some embodiments, for example, the reactive process, that is effected in response to the contacting of the carbonylation-ready residual solid material and the metal carbonyl formation reagent, effects the production of the metal carbonyl material-comprising material. In some embodiments, for example, the metal carbonyl formation reagent includes gaseous carbon monoxide. In some embodiments, for example, the contacting with a metal carbonyl formation reagent is effected within a fourth material transformation zone 260. In those embodiments where the at least one non-lithium metal includes nickel and cobalt, in some of these embodiments, for example, the at least one metal carbonyl includes nickel carbonyl and cobalt carbonyl.

In some embodiments, for example, the at least one metal carbonyl includes at least one gaseous metal carbonyl and at least one solid metal carbonyl. In some embodiments, for example, the contacting of a carbonylation-ready residual solid material 240, deriving from the reduced residual solid material 220, and a metal carbonyl formation reagent 250 is with effect that a carbonylation product material 270 is produced, and the carbonylation product material 270 includes a post-carbonylation gaseous material 280 and a post-carbonylation residual solid material 290. The post-carbonylation gaseous material 280 includes the at least one gaseous metal carbonyl and the post-carbonylation residual solid material 290 includes the at least one solid metal carbonyl. In some of these embodiments, for example, the post-carbonylation gaseous material 280 is separated from the post-carbonylation residual solid material 290 via gravity separation. With respect to the separated post-carbonylation residual solid material 290, in some embodiments, for example, a gaseous sublimation product 310 is separated from the post-carbonylation residual solid material 290, via sublimation (such as, for example, within a fifth material transformation zone 300), and the gaseous sublimation product 300 includes at least one of the at least one solid metal carbonyl of the post-carbonylation residual solid material 290. The separation of the gaseous sublimation product 310, from the post-carbonylation residual solid material 290, is with effect that a post-sublimation residual product material 305 is obtained.

In those embodiments where the at least one non-lithium metal includes nickel and cobalt, in some of these embodiments, for example, the at least one gaseous metal carbonyl includes nickel carbonyl and the at least one solid metal carbonyl includes cobalt carbonyl, and the post-carbonylation gaseous material 280 includes the nickel carbonyl, while the gaseous sublimation product 310 includes the cobalt carbonyl. In this respect, in some embodiments, for example, the temperature of the fourth material transformation zone 260 is from 150 degrees Celsius to 200 degrees Celsius, and the pressure of the fourth material transformation zone 260 is from 1000 psi to 2750 psi, and the fifth material transformation zone 300 has a temperature that is greater than 40 degrees Celsius and has a pressure that is less than 100 psi.

In some embodiments, for example, for each one of the at least one metal carbonyl of the post-carbonylation gaseous material 280, independently, a respective elemental metal 330, of the metal carbonyl, is recovered via a decomposition of the metal carbonyl (such as, for example, within a sixth material transformation zone 320). Similarly, for each one of the at least one metal carbonyl of the gaseous sublimation product 310, independently, a respective elemental metal 350, of the metal carbonyl, is recovered via a decomposition of the metal carbonyl (such as, for example, within a sixth material transformation zone 340). In this respect, one or more elemental metals, deriving from the black mass, is recovered via carbonylation.

In some embodiments, for example, each one of the one or more elemental metals (recovered via the carbonylation), independently, is then contacted with an aqueous acid to produce a respective metal salt, which is of a useable form for battery production.

In some embodiments, for example, the post-sublimation residual product material 305 include a non-lithium metal, such as, for example, manganese, and at least one of the at least non-lithium metal is recovered hydrometallurgically.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A process for recovering one or more metals from black mass, comprising:
contacting the black mass with a soluble lithium material formation reagent with effect that a conditioned black mass material is produced, wherein the conditioned black mass material includes a lithium-comprising ionic compound material that is defined by at least one lithium-comprising ionic compound;
contacting a lixiviant-ready black mass material, deriving from the conditioned black mass material, with a lixiviant, with effect that a lixiviant-conditioned mixture is produced; and
separating a separation-ready mixture, deriving from the lixiviant-conditioned mixture, into at least a lithium-rich liquid material and a lithium-depleted residual solid material.

2. The process as claimed in claim 1;
wherein:
the contacting of a lixiviant-ready black mass material with a lixiviant is with effect that leaching of the lixiviant-ready black mass material is effected.

3. The process as claimed in claim 2;
wherein:
the leaching is with effect that a leachate is produced; and
the leachate includes the lithium-comprising ionic compound material.

4. The process as claimed in claim 3;
wherein:
the lithium-rich liquid material is derived from the leachate.

5. The process as claimed in claim 1;
wherein:
the lixiviant is an aqueous liquid.

6. The process as claimed in claim 1;
further comprising:
recovering elemental lithium from the lithium-rich aqueous material.

7. The process as claimed in claim 6;
further comprising:
contacting a reduction-ready residual solid material, derived from the lithium-depleted residual solid material, with a reducing agent, with effect that a reduced residual solid material is produced.

8. The process as claimed in claim 7;
producing at least one metal carbonyl, deriving from the reduced residual solid material; and
from each one of the at least one metal carbonyl, independently, recovering an elemental metal that is respective to the metal of the metal carbonyl.

9. The process as claimed in claim 8;
wherein:
for each one of the at least one metal carbonyl, independently, the production of the metal carbonyl is effected via a carbonylation.

10. The process as claimed in claim 1;
wherein:
the ratio, of: (i) the concentration of lithium within the lithium-rich liquid material to (ii) the concentration of lithium within the lithium-depleted residual solid material, is at least four (4).

11. The process as claimed in claim 1;
wherein:
the lithium-depleted residual solid material includes less than three (3) weight % lithium, based on the total weight of the lithium-depleted residual solid material.

12. The process as claimed in claim 1;
wherein:
the black mass includes at least one non-lithium metal;
the lithium-rich liquid material includes dissolved lithium and at least one dissolved non-lithium metal.
for each one of the at least one dissolved non-lithium metal, independently, the dissolved non-lithium metal is derived from a respective one of the at least one non-lithium metal of the black mass, such that the at least one dissolved non-lithium metal is derived from a respective at least one non-lithium metal of the black mass;
the black mass and the soluble lithium material formation reagent are co-operatively configured such that the ratio, of: (i) the fraction of the total weight of lithium, of the black mass, that is lithium from which the dissolved lithium is derived to (ii) the fraction of the total weight of the at least one non-lithium metal, of the black mass, that is the respective at least one non-lithium metal from which the at least one dissolved non-lithium metal is derived, is at least 16.

13. The process as claimed in claim 1;
wherein:
the lithium, of the lithium-rich liquid material, is derived from the black mass.

14. The process as claimed in claim 1;
wherein:
the soluble lithium material formation reagent includes a halide ion-donating material.

15. The process as claimed in claim 14;
wherein:
the halide-ion donating material is a metal-based halide ion donating material.

16. The process as claimed in claim 14;
wherein:
the contacting of the black mass with the soluble lithium material formation reagent is effected within a contacting zone; and
within the contacting zone, the ratio, of: (i) the total number of moles of halogen atoms to (ii) the total number of moles of lithium atoms, is at least 1:1.

17. The process as claimed in claim 14;
wherein:
within the contacting zone, the ratio, of: (i) the total weight of the soluble lithium material formation reagent to (ii) the total weight of the black mass, is from 1:99 to 1:4.

18. A process for recovering one or more metals from black mass, comprising:
separating lithium from the black mass such that a lithium-depleted black mass is obtained; and
converting at least a portion of the lithium-depleted black mass, via a reactive process, to at least a non-lithium elemental metal.

19. The process as claimed in claim 18;
wherein:
the lithium-depleted black mass includes less than three (3) weight % lithium, based on the total weight of the lithium-depleted black mass.

20. The process as claimed in claim 18;
wherein:
the black mass includes five (5) weight % to 15 weight % of lithium, based on the total weight of the black mass.

21. The process as claimed in claim 18;
wherein:
the converting includes contacting a reducing-ready black mass, derived from the lithium-depleted black mass, with a reducing agent, with effect that a non-lithium elemental metal is produced.
